(19) United States
(12) Patent Application Publication
(10) Pub. No.: US 2009/0218038 A1
(43) Pub. Date: Sep. 3, 2009

(54) Method for Manufacturing Curved Components for Furniture, Particularly Doors for Furniture

(76) Inventor: Renzo Kerkoc, Bologna (IT)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 12/086,490

(22) PCT Filed: Dec. 15, 2006
(86) PCT No.: PCT/IB2006/003632

§ 371 Date: Mar. 27, 2009

(30) Foreign Application Priority Data
Dec. 16, 2005 (IT) MO2005A000336

(51) Int. Cl. B29C 65/48

(52) U.S. Cl. 156/196; 156/245; 156/263; 156/276

(57) ABSTRACT

This invention refers to a method for manufacturing curved components (1) for furniture, particularly doors for furniture, comprising: a cold shaping phase of a first panel (2) made in a wooden, plastic or metal material to curve the first panel; a cold shaping phase of a second panel (4) made in a wooden, plastic or metal material to curve the second panel; a cold overlapping phase of the first curved panel, of at least one intermediate separating layer (3) and of the second curved panel by interposing glue between the intermediate layer and the first and second curved panel to make a curved component for furniture.

### TECHNICAL FIELD

This invention refers to a method for manufacturing curved components for furniture, particularly doors for furniture.

### BACKGROUND ART

It is common knowledge that in the furnishing sector like, for instance, in the production of modern style furniture, other materials are used as an alternative to solid wood which make it possible to achieve many different decorative effects.

In particular, the use of multilayer materials is known for producing curved furnishing components, such as doors for furniture, obtained by putting a plurality of panels of different materials on top of each other and rendered one by gluing them together.

Alternatively, the known doors are made in honeycomb core panels which are made by putting one or more layers of filler material between two exterior panels, giving an extremely lightweight product without undermining its resistance.

One of the known methods for manufacturing curved doors in honeycomb core panel, for example, entails making the stratified product in a flat configuration, obtained by putting the various layers on a workbench with thermosetting glues in between, ureic glues for instance, and then the product is pressed inside a shaped mould to impart the degree of curvature wanted.

Today pressing is done in presses featuring heating means which help the glue harden better and quicker.

For this purpose electromagnetic wave generators are usually employed connected to adjustment units that act by energising and, consequently, heating the molecules of the glue during the pressing phase.

Generally speaking, the known doors are made of two exterior plywood panels with a decoration applied to the visible sides, between which a layer of filler material is inserted made of a pair of strips in wooden material, placed by the two parallel sides of the exterior panels and separated by a sheet of paper material that fills the gap defined between the panels and the strips.

Cold roll coating machines are necessary for making these doors, to spread the glue over the top and bottom of the strips and sheet, as well as presses complete with special moulds and featuring units to adjust the wave generator.

These known methods are not without drawbacks, among which is the fact that, particularly for the exterior panels, materials have to be used that can withstand traditional working conditions without being damaged plus the fact that their cost negatively and considerably influences the unit cost of the products made.

Moreover, since the doors have to stay inside the heated presses for a time that guarantees the gluing together of the various materials—about 15 minutes each piece—the production output of such systems is greatly restricted.

Another limit of the known methods is due to the fact that the presses utilised must be equipped with a complicated, energy consuming and costly electronic apparatus for the controlled generation of waves that help the glue harden.

By no means least is the heating inside the press which gives rise to the dangerous formation of electric arcs which burn the moulds and the products being manufactured, causing economic losses linked to damaged materials and moulds, the maintenance of which is very expensive.

Lastly, the people making the known doors are permanently exposed to serious risks for their health due to the magnetic fields caused by the heating waves and to the high fire risks on the work premises.

To find a remedy for these drawbacks, a second method is known for the production of curved doors using honey comb core panels, which entails making the most exterior panels in agglomerated wood fibre based materials, compacted and assembled by interposing a binder, commercially known as MDF (Medium Density Fibre), the cost for which per cubic metre is about one third of that for traditional plywood.

By using a glue, of the pressure reactive type, and in particular polyurethane glue, combined with a material comprising wood fibres, it is possible to obtain a cold shape because, at ambient temperature, by means of a suitable pressure, this glue hardens quickly and guarantees a solid and firm connection between the various materials while keeping the shape curved.

Gluing is subsequently completed by the chemical reaction that occurs between the glue and ambient humidity.

But this method too requires further improvement.

We would, in fact, like to point out that when shaping the end component—after gluing—structural stresses are created inside it that can be harmful especially in terms of the door's resistance over time, generally limiting the actual quality of the panel.

### PURPOSE OF THE INVENTION

The primary aim of this invention is to eliminate the drawbacks of the known state of the art complained of above and to devise a method for manufacturing curved components for furniture, particularly doors for furniture, that will implement the above mentioned improvements.

Within this technical aim, another purpose of this invention is to lower the unit cost of the products made without in any way prejudicing their quality level.

Another purpose of the invention is to speed up work, increasing production output and the efficiency of the systems used.

Another purpose of the invention is to eliminate the above mentioned risks from the work place that are dangerous for the operator's health.

This aim and these purposes are all achieved by this method for manufacturing curved components for furniture, particularly doors for furniture, characterised by the fact that it comprises: a cold shaping phase of a first panel made in a wooden, plastic or metal material to curve the first panel; a cold shaping phase of a second panel made in a wooden, plastic or metal material to curve the second panel; a cold overlapping phase of the first curved panel of at least one intermediate separating layer and of the second curved panel by interposing glue between the intermediate layer and the first and second curved panel to make a curved component for furniture.

### BRIEF DESCRIPTION OF THE DRAWINGS

Further characteristics and advantages of this invention will appear even more evident from the detailed description of a preferred, but not exclusive, form of embodiment of a method for manufacturing curved components for furniture, particularly doors for furniture, illustrated indicatively by way of non limiting example, in the attached drawings wherein:

FIG. 1 is a schematic section view illustrating the shaping phase of one of the component panels obtained with the method according to the invention;

FIG. 2 is a schematic section view of a curved semi finished product during the overlapping phase of the method according to the invention;

FIG. 3 is a schematic section view of the curved component after completion of the overlapping phase of the method according to the invention;

FIG. 4 is an axonometric schematic view of a curved component for furniture that can be made with the method subject of the invention.

### FORMS OF EMBODIMENT OF THE INVENTION

With special reference to such figures, a curved component for furniture that can be made with the method subject of the invention has been globally designated by reference number 1.

The component 1 comprises a first panel 2 made in a wooden, plastic or metal material, a separating intermediate layer 3 and a second panel 4 in a wooden, plastic or metal material, placed one on top of the other and joined by glue spread between them, and has a curved shape.

In the particular form of embodiment represented in the figures, the component 1 is substantially cylindrical in shape, but alternative forms of embodiment cannot however be ruled out wherein it features different curves.

Advantageously, the wooden material making up the first panel 2 and the second panel 4 is the type comprising agglomerated wood fibres like, for example, MDF; alternatively, as mentioned above, plastic or metal may also be envisaged.

The first panel 2, the intermediate layer 3 and the second panel 4 have shapes and extensions of the contacting surfaces that coincide and are arranged one on top of the other so their perimeters match together.

In the particular form of embodiment represented, these surfaces are quadrangular in shape and their length and width coincide.

The intermediate layer 3 comprises two strips 5 placed parallel to one another with a sheet 6 of material which is as thick as the strips 5 between them.

The strips 5 are made in poplar chipboard or plywood, MDF, etc., (for example plastic or metal) while the material of the sheet 6 is honeycomb structure paper or foam polymer.

The strips 5 and the sheet 6 are arranged parallel to the generatrices of the curved shape of the component 1.

The intermediate layer 3 is thicker than the first panel 2 and second panel 4 so that the component 1 is relatively thick but not heavy.

Decorative coatings can be applied, not shown in the figures, on the visible sides 2a and 4a of the panels 2 and 4 respectively, which can be paper or PVC printed with a wood design, strips of wood or something else.

The method according to the invention is the following: the application phase of decorative coating is made on the visible sides 2a and 4a of panels 2 and 4 initially flat; then the cutting phase takes place through the cut of the first panel 2, the second panel 4, the strips 5 and the sheet 6 to bring them to size.

At this point the cold shaping phases are carried out of the first panel 2, the sheet 6 and the second panel 4 to curve them.

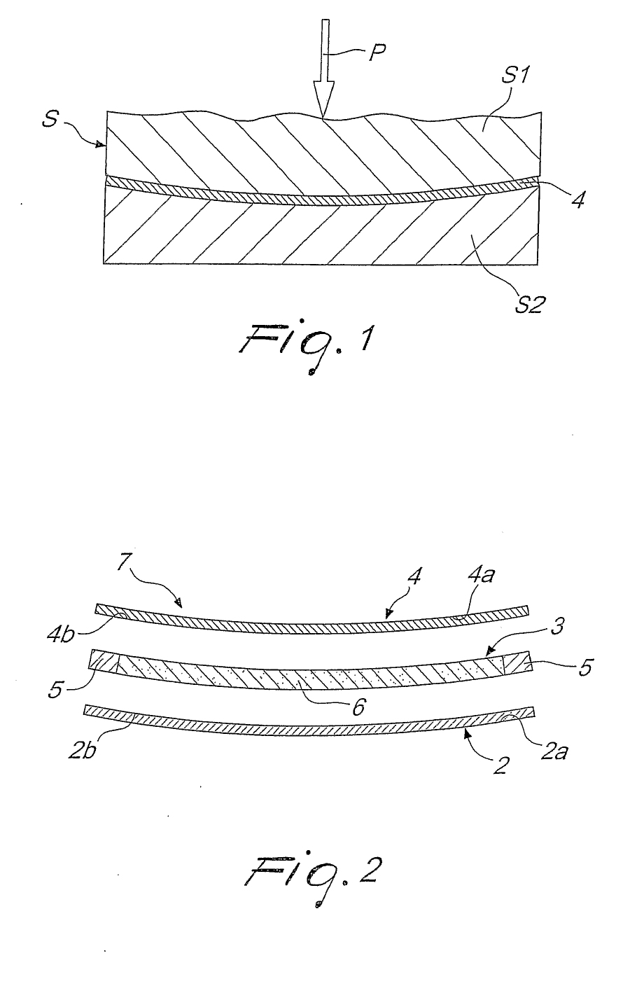

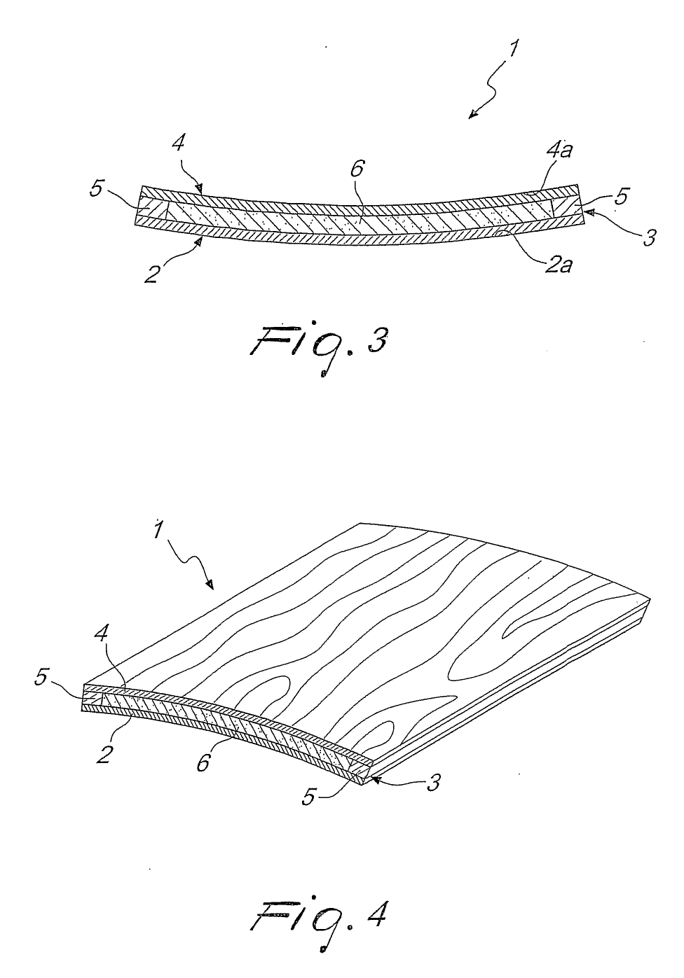

FIG. 1 schematically illustrates this phase with particular reference to the shaping of the second panel 4; shaping of panel 2 and sheet 6 is not shown in the above figures as it is identical to that of panel 4.

Usefully, these shaping phases take place inside a mould S, its shape complementary to the one to be achieved, and composed of an upper movable portion S1 that is cylindrical and convex in shape, and a lower fixed portion S2 that is cylindrical and concave in shape.

The spreading phase of hot glue is then carried out over the laying surface 2b of the first curved panel 2, designed to be associated with the intermediate layer 3, and then takes place the overlapping phase of the intermediate layer 3 on top of the first panel 2 so their perimeters match, having previously placed the first panel 2 on a workbench with the visible side 2a downwards.

The overlapping phase of the intermediate layer 3 on top of the first panel 2 consists in arranging the strips 5 on the first panel 2, on two of its parallel sides, and then putting the sheet 6 between the strips 5.

The spreading phase of hot glue is then carried out over the laying surface 4b of the second panel 4, designed to be coupled to the intermediate layer 3 and then takes place the overlapping phase of the second panel 4, arranged with its visible side 4a facing up, on the intermediate layer 3 so their respective perimeters match, giving a semi finished product 7.

A traditional hot roller spreading machine can be used to spread the glue over the laying surfaces 2b and 4b.

By spreading the glue on hot keeps it fluid to ensure even distribution over the first panel 2 and second panel 4 without damaging them.

Alternatively, it could be envisaged a hot spreading phase of glue over the opposite sides of the intermediate layer 3.

Other alternative forms of embodiment of this method are not excluded however, where the glue is advantageously of the removable type and it entails an application phase of a protective film on the layer of glue spread over panels 2 and 4 or on the intermediate layer 3.

This protective film, that can be taken off the surface on which the glue is spread just before overlapping the first panel 2, the intermediate layer 3 and the second panel 4 does, in fact, allow to handle and transport the panels 2 and 4 and the intermediate layer 3 separately from one another and join them only when needed to make the semi finished product 7.

The semi finished product 7 is then sent on for a cold pressing phase which joins the first panel 2, the intermediate layer 3 and the second panel 4 together to make the component 1.

This phase is carried out keeping the semi finished product 7 for 1 to 3 minutes under the action of a pressure p ranging between 49000 Pa (0.5 Kg/cm²) and 196133 Pa (2 Kg/cm²) at ambient temperature.

Pressing can be done using traditional static presses, placing the semi finished product 7 inside a mould and leaving it closed inside the press at ambient temperature for the established time under the action of pressure P.

The semi finished product 7 is placed inside the mould with the strips 5 and the sheet 6, parallel with the generatrices of the curved shape you want to create.

In this case, the cutting phase is done to bring the first panel 2, the intermediate layer 3 and the second panel 4 to the size of the mould.

Advantageously, by using a pressure reactive glue, in particular a polyurethane glue, combined with a wood fibre, plastic or metal material, makes cold pressing possible because, at ambient temperature and under the action of an adequate pressure, this glue hardens quite quickly—just a few minutes—and guarantees firm and stable adherence between the various materials while keeping the shape curved.

The pressure reacting glues penetrate the porosity of the surfaces they have to join and under the action of pressure develop chemical reactions that make setting easy, thus guaranteeing a gluing that is firm and stable between the surfaces.

Gluing is then completed by the chemical reaction between the glue and ambient humidity.

Alternatively, pressing can be done using traditional type profiling roller units that provide the added advantage of a continuous production which is possible thanks to the speed at which the glues used harden.

The pressing phase is followed by a waiting phase, shorter compared to the time normally needed for the processes known today, that is the curved component 1, extracted previously from the mould S, has to wait a few hours before it can be sent on to the next working processes to guarantee the glue is completely hard.

As an alternative to the described execution, the decorative coating can be applied on one or both visible sides after the pressing phase.

It has in practice been seen how the described invention achieves the intended purposes.

More specifically, by shaping the single panels and sheet prior to overlapping them, it means no harmful structural stresses are created inside the component.

One other advantage of this invention is that the working processes are far quicker than traditional methods where hot pressing is used, meaning higher production output and more efficient systems.

In addition, the fact should be stressed that with the method according to the invention, the above mentioned risks for the health of the operators are eliminated from the work place and, as no heating is required during pressing, longer moulds can be made compared to traditional ones or even multiples in height if the press used has more than one compartment.

The invention thus conceived is susceptible of numerous modifications and variations, all of which falling within the scope of the inventive concept.

Furthermore all the details may be replaced by other elements which are technically equivalent.

In practice, all the materials used, as well as the contingent shapes and dimensions, may be any according to requirements without because of this moving outside the protection scope of the following claims.

1. Method for manufacturing curved components for furniture, particularly doors for furniture, comprising:
a cold shaping phase of a first panel made in a wooden, plastic or metal material to curve said first panel;
a cold shaping phase of a second panel made in a wooden, plastic or metal material to curve said second panel;
a cold overlapping phase of said first curved panel, of at least one intermediate separating layer and of said second curved panel by interposing glue between said intermediate layer and said first and second curved panel to make a curved component for furniture.

2. Method according to claim 1, wherein said wooden material is of the type comprising agglomerated wood fibres.

3. Method according to claim 1, wherein said glue is of the pressure reactive type.

4. Method according to claim 1, wherein said glue is of the humidity reactive type.

5. Method according to claim 1, wherein said glue is of the polyurethane type.

6. Method according to claim 1, wherein said overlapping phase comprises the cold pressing of said first panel, said intermediate layer and said second panel for a time interval ranging between 1 and 3 minutes with a pressure ranging between 49000 Pa and 196133 Pa.

7. Method according to claim 6, wherein said pressing is done using static presses.

8. Method according to claim 6, wherein said pressing is done using profiling roller units.

9. Method according to claim 1, comprising a hot spreading phase of said glue over the surface of at least one between said first and second curved panel, designed to be associated with said intermediate layer.

10. Method according to claim 1, comprising a hot spreading phase of said glue over at least one of the surfaces of said intermediate layer, designed to be associated with said first and second curved panels.

11. Method according to claim 1, comprising an application phase, over said glue, of a removable protective film before said overlapping phase.

12. Method according to claim 1, comprising an application phase of a decorative coating on the visible side of at least one of said first and second panels.

13. Method according to claim 1, comprising a cutting phase of said first and second panel and of said intermediate layer.

14. Method according to claim 1, comprising a waiting phase of said component to facilitate the setting of said glue.

15. Method according to claim 1, wherein said intermediate layer comprises two strips placed substantially parallel to one another and with a sheet of honeycomb structure paper or foam polymer material between them, said strips and said sheet having substantially the same thickness.

16. Method according to claim 15, comprising a cold shaping phase of said sheet to curve it.

17. Method according to claim 16, wherein said cold shaping phases comprise the moulding of at least one between said first panel, said second panel and said sheet inside moulds designed to give any curved shape.
